(19) United States
(12) Patent Application Publication
(10) Pub. No.: US 2020/0010696 A1
(43) Pub. Date: Jan. 9, 2020

(54) ANTICORROSION COATING AND ARTICLE MADE THEREFROM

(71) Applicant: Illinois Tool Works Inc., Glenview, IL (US)

(72) Inventors: Stuart Ira Yaniger, Glenview, IL (US); Douglas E. Moon, Glenview, IL (US)

(21) Appl. No.: 16/506,816

(22) Filed: Jul. 9, 2019

Related U.S. Application Data
(60) Provisional application No. 62/695,447, filed on Jul. 9, 2018.

(51) Int. Cl. C09D 5/08; C09D 183/08

(52) U.S. Cl. CPC C09D 5/086; C09D 183/08

(57) ABSTRACT

A corrosion inhibiting coating is applied to a target substrate that includes dual- or poly-terminus siloxane having pendant and/or terminal amine or thiol moieties reacted with a strained ring alkoxysilane. The siloxanes adhered to susceptible surface with a tertiary amine or divalent mercaptan chain linker extending therebetween. The resulting coating functions as a corrosion inhibitor, and in some embodiments as a primer for subsequent painting. The resulting coating is generally invisible to the unaided human eye. A process of forming the corrosion inhibiting coating includes forming a water or solvent based emulsion solution by combining a solvent and/or water with suitable surfactants, an amine functional silicone fluid, and a strained ring containing alkoxysilane reactive with a nitrogen or sulfur containing curative chain linker.

### RELATED APPLICATIONS

This application claims priority benefit of U.S. Provisional Application Ser. No. 62/695,447 filed 9 Jul. 2018; the contents of which are hereby incorporated by reference.

### FIELD OF THE INVENTION

The present invention in general relates to anticorrosion coatings, and in particular, to a coating formed as the reaction product of a strained ring alkoxysilane and a nitrogen or sulfur containing chain linker, and the combination of this reaction product with the surface of a metal substrate to which the reaction product is applied.

### BACKGROUND OF THE INVENTION

Corrosion typically refers to the oxidation or other undesirable surface reactions of metals in the presence of water or water vapor. Common examples of corrosion include rust formation on the surface of iron and steel, white rust forming on galvanized steel, tarnishing of silver, staining and pitting of aluminum, and the oxidation or tarnishing of copper. Additional forms of corrosion, which may lead to failures, include tarnishing, pitting, flaking, and spalling.

Mechanisms for corrosion may include corrosion caused by exposure to atmospheric conditions, or exposure of a metal surface to water, soil, or chemicals. Factors that increase the rate and extent of corrosion include mechanical stress, temperature, etc. From an economic, safety and aesthetic standpoint, atmospheric corrosion is one of the most important types of corrosion to prevent. Atmospheric corrosion is enabled by atmospheric humidity and stimulated by pollutants in the atmosphere such as acid gases such as sulfur dioxide (SO₂), hydrogen sulfide (H₂S), and carbon dioxide (CO₂)], nitrogen oxides (NO and NO₂), ozone (O₃), and salts (chlorides and sulfides). FIG. 1 illustrates a prior art schematic of the chemical reactions that occur during the corrosion of steel.

Methods for controlling corrosion of materials include preventing the materials from contact with water, prevention of oxidation reduction (redox) reactions with oxygen or sulfur, and preventing the materials' anode and cathode from having electrical contact. Existing physical corrosion protection methods include the removal of humidity and oxygen from a material susceptible to corrosion. Materials susceptible to corrosion maybe be stored and transported in special packaging in the form of polyethylene (PE) bags usually in combination with desiccants, an aluminum foil barrier in combination with desiccants, vacuum packaging, and the use of protective gases illustratively including oxygen scavenging, ethylene absorbing, and other inert gases.

Materials susceptible to corrosion may have their surfaces passivated. Passivation involves modifying the surface of a material by a self-limiting oxidation that isolates the anode and cathode as shown in prior art FIGS. 2A-2C.

Materials susceptible to corrosion may also have their surfaces treated with barrier coatings to help prevent corrosion. Barrier coatings include: naturally derived oils and fluids; corrosion protection inhibitors (vapor corrosion inhibitor (VCI) films, VCI papers, VCI cardboards etc.); varnishing (e.g., acrylic, epoxy); and synthetic oil coating. Barrier coatings must be removed before surface finishing of the material.

Thin film barriers to prevent corrosion involve the attachment of molecules to the treated materials' surface that provide a hydrophobic barrier. FIG. 3 illustrates a prior art hydrophobic barrier on a material substrate. Thin film barriers are typically formed with fatty acid or fatty phosphates.

Chemical films may be applied to the surfaces of materials to prevent corrosion. Chemical films may be solvent based fluids that leave behind a rust-preventative coat after evaporating, and are usually applied by brushing, spraying or dipping. Chemical films may also be water based fluids. Water based chemical films have low or no volatile organic compounds (VOCs) and are water based emulsions of film formers with active additives.

Chemical film additives may include corrosion specific additives to film-forming organics illustratively including H₂S inhibitors, amines, and borates. These non-volatile additives can make an ordinary film type barrier corrosion protection system into a customizable active and passive system unavailable with VCI. Common corrosion inhibitors illustratively include alkyl dicarboxylates as shown in prior art FIG. 4A, triethanolamine and triethanolamine borate as shown in prior art FIG. 4B.

Inorganic inhibitors include anodic (phosphates, molybdates, chromates, nitrates) and cathodic (magnesium, zinc, nickel).

While there are existing chemical films and barrier layers to prevent corrosion of substrates to which they are applied, these films and barriers generally are too thick (>20 microns), and generally need to be removed before secondary operations (e.g., painting), or have potentially hazardous vapors.

Thus, there exists a need for improved anti-corrosion coatings with reduced thicknesses that may be left on coated substrates and are available for secondary operations.

### SUMMARY OF THE INVENTION

A corrosion inhibiting coating applied to a target structure includes dual- or poly-terminus siloxane having pendant and/or terminal amine or thiol moieties reacted with a strained ring alkoxysilane. The siloxanes are adhered to susceptible surface with a tertiary amine or divalent mercaptan chain linker between the siloxanes. In some embodiments, the tertiary amine chain linker has a pendant hydrophobic group. The resulting coating functions as a corrosion inhibitor, and in some embodiments as a primer. The resulting coating is generally invisible to the unaided human eye.

A process of forming the corrosion inhibiting coating includes forming a water or solvent based emulsion solution by combining a solvent and/or water with suitable surfactants, an amine functional silicone fluid, and a strained ring containing alkoxysilane reactive with a nitrogen or sulfur containing curative chain linker. Additives are also readily included. Water can be either added to a solvent-based composition or the composition may be applied unreacted and allowed to cure via atmospheric moisture.

### BRIEF DESCRIPTION OF THE DRAWINGS

FIG. 1 illustrates the prior art chemical reactions that occur during the corrosion of steel;

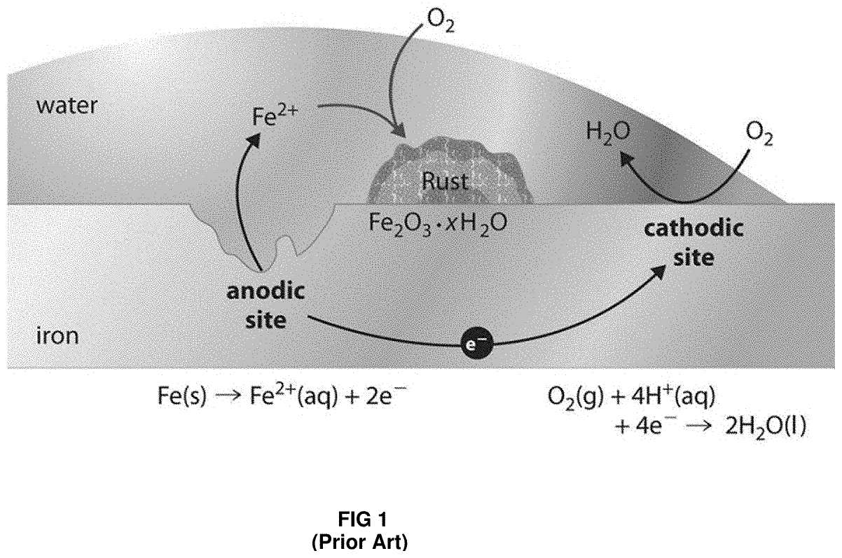

FIGS. 2A-2C illustrate a prior art existing passivation process that involves modifying the surface of a material by oxidation in order to isolate the anode and cathode;

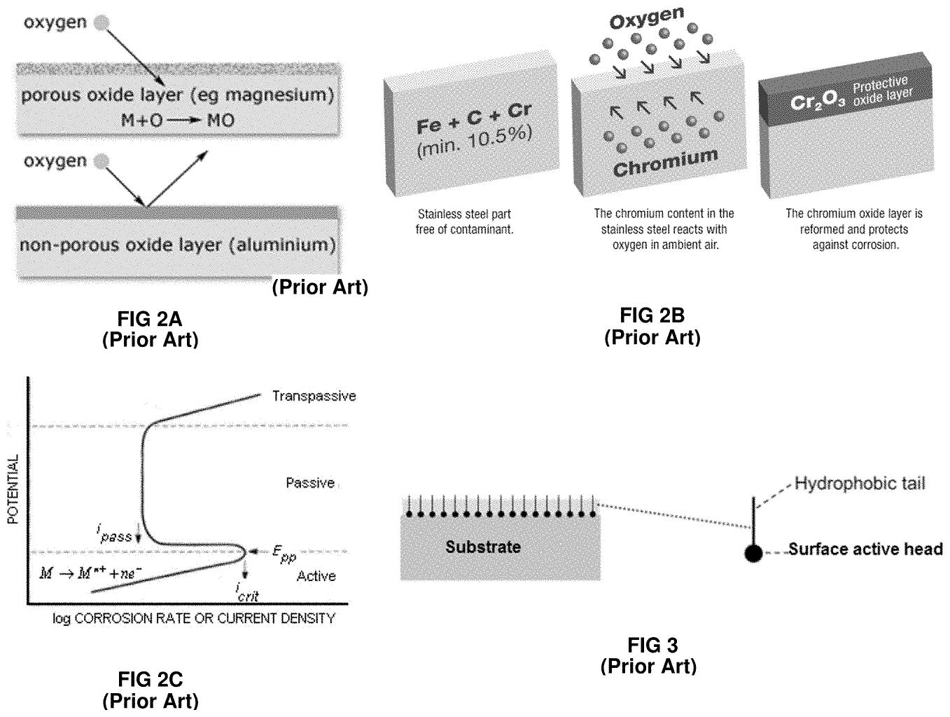

FIG. 3 illustrates a prior art process of forming a hydrophobic barrier on a material substrate;

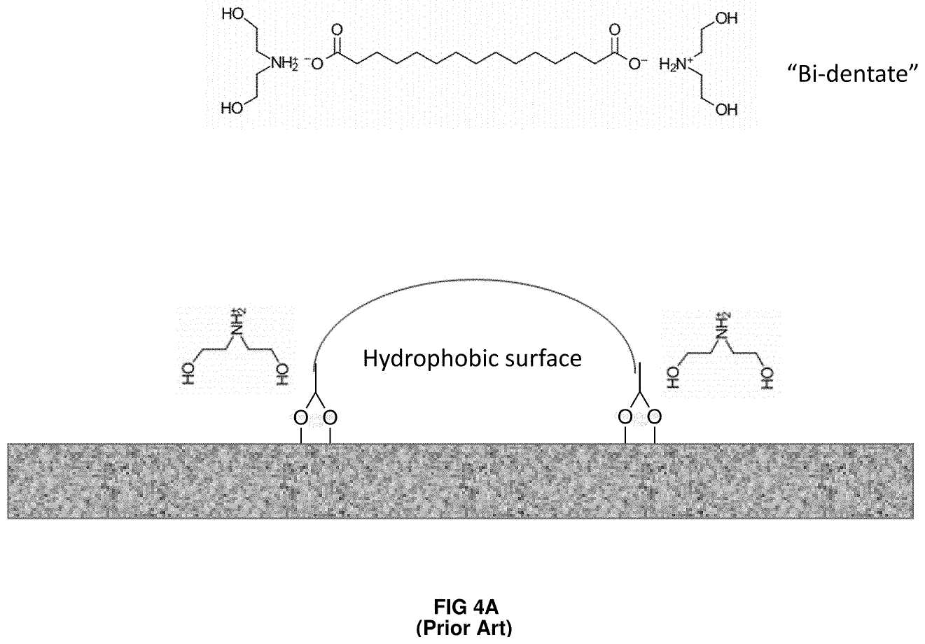

FIGS. 4A and 4B illustrate prior art chemical reactions for formation of surface corrosion inhibitors including alkyl dicarboxylates, and triethanolamine and triethanolamine borate, respectively; and

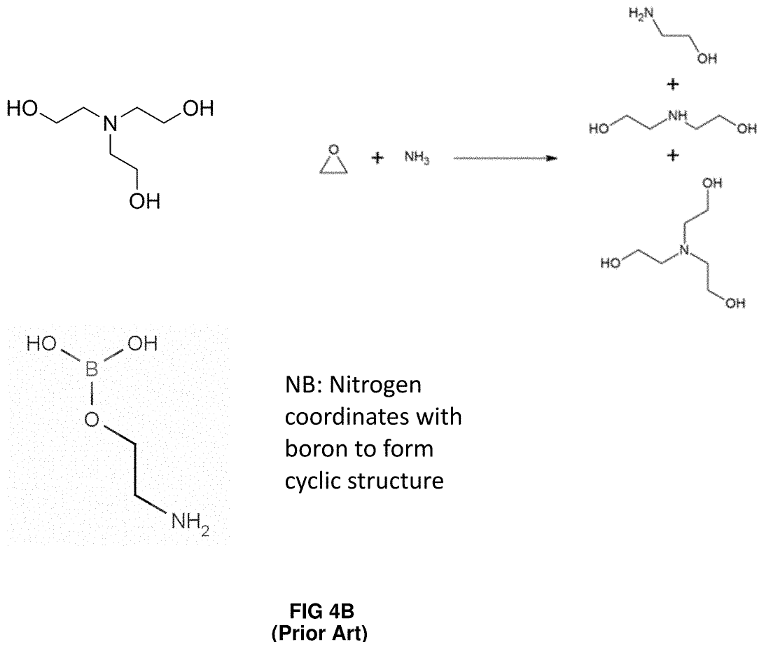

FIG. 5 illustrates an exemplary bonding reaction between mono ethanolamine and two strained ring alkoxy silanes depicted as gamma glycidoxy propyl trimethoxy silane (GLYMO).

### DETAILED DESCRIPTION OF THE PREFERRED EMBODIMENTS

The present invention has utility as a corrosion inhibiting coating that includes the reaction product of a strained ring alkoxysilane with a functional silicone fluid or an alkoxysilane, and the combination of this reaction product with the surface of a target metal substrate, most particularly steel or aluminum. It is appreciated that metal oxides, ceramics, concrete, and cellulosics such as wood also benefit from the inventive coatings. Embodiments of the inventive coating composition, when applied to the surface of a target substrate, provide resistance to corrosion from salt spray, acid environments, and atmospheric moisture. Embodiments of the inventive coating composition form an extremely thin (<10 microns) solid coating on the metal surface unlike prior art existing coatings that are generally thicker (>20 microns), and generally need to be removed before secondary operations (e.g., painting), or have potentially hazardous vapors. Target substrates specifically include external metal components of a vehicle.

Embodiments of the inventive corrosion inhibiting coating provide a hard and thin film which is not greasy, oily, or waxy, has no significant vapor pressure, and the coated object is amenable to being directly painted over or powder coated. The inventive corrosion inhibiting coating may be applied by wiping or spraying and cures within 24 hours. The corrosion inhibiting coating is thin enough not to affect dimensional tolerances of surfaces, holes, protrusions, or threads and is invisible (i.e, optically transparent) to the unaided normal human eye. Objects with the composition coating resist direct salt spray and exposure to formic acid vapors, and hence may make transit coatings to prevent corrosion of packaged and shipped and/or stored metal objects.

It is to be understood that in instances where a range of values are provided, for example with respect to a weight percentage range of a composition component, that the range is intended to encompass not only the end point values of the range but also intermediate values of the range as explicitly being included within the range and varying by the last significant figure of the numeral. By way of example, a recited range of from 1 to 4 is intended to include 1-2, 1-3, 2-4, 3-4, and 1-4.

Embodiments of the inventive corrosion inhibiting coating employ chemical coupling based on ethanolamines to form ultra-thin layers (<10 microns) with customizable adhesion and surface characteristics that include tunable hydrophobicity and increased adhesion of finishes including but not limited to paints, E-coatings, and powder coatings.

An inventive coating is created by the amine or thiol cure of a strained ring to form a secondary or tertiary amine or thiol with a silane functionality used to adhere with a target substrate.

A strained ring alkoxysilane operative herein is a monomer or oligomer that typically has an average molecular weight of less than 4,000 Daltons having a formula (IA):

(OCH₂CH)—R¹—X—R²—Si—(OR³)₃ (IA)

where R¹ is C₁-C₄ alkyl, (CH₂)ₓCH═CH, or (CH₂)_{y}CH═CH(CH₂)_{z} where x or (y+z) is an integer of 0 to 4 inclusive, (CH₂)ⱼC≡C, or (CH₂)ₖC≡C(CH₂)ᵣ where j or (k+r) is an integer of 0 to 4 inclusive, an aromatic, a heteroaromatic, or together with (OCH₂CH) forms epoxycyclopentyl (OC₅H₇), epoxycyclohexyl (OC₆H₉), or epoxycycloheptyl (OC7H₁₁); X is a nullity, nitrogen, sulfur, or oxygen, R² is C₂-C₆ alkyl, (CH₂)ₓCH═CH, or (CH₂)_{y}CH═CH(CH₂)_{z} where x or (y+z) is an integer of 0 to 20 inclusive, (CH₂)ⱼC≡C, or (CH₂)ₖC≡C(CH₂)ᵣ where j or (k+r) is an integer of 0 to 20 inclusive, an aromatic, a heteroaromatic, R³ in each occurrence is independently C₁-C₆ alkyl. It is appreciated that an alkyl as used herein is linear, branched or cyclic with the proviso that cyclic alkyls are C₄-C₆. Strained ring alkoxysilanes operative herein illustratively include 2-(3,4 epoxycyclohexyl) ethyltrimethoxysilane, 3-glycidoxypropyl trimethoxysilane, 3-glycidoxypropyl triethoxysilane, and combinations thereof.

In other inventive embodiments, a strained ring alkoxysilane operative herein is a monomer or oligomer that typically has an average molecular weight of less than 4,000 Daltons having a formula (IB):

(OCH₂CH)—R¹—X—R²—Si—(Yₙ)(OR³)₃₋ₙ (IB)

where R¹ is C₁-C₄ alkyl, (CH₂)ₓCH═CH, or (CH₂)_{y}CH═CH(CH₂)_{z} where x or (y+z) is an integer of 0 to 4 inclusive, (CH₂)ⱼC≡C, or (CH₂)ₖC≡C(CH₂)ᵣ where j or (k+r) is an integer of 0 to 4 inclusive, an aromatic, a heteroaromatic, or together with (OCH₂CH) forms epoxycyclopentyl (OC₅H₇), epoxycyclohexyl (OC₆H₉), or epoxycycloheptyl (OC7H₁₁); X is a nullity, nitrogen, sulfur, or oxygen, R² is C₂-C₆ alkyl, (CH₂)ₓCH═CH₂, or (CH₂)_{y}CH═CH(CH₂)_{z} where x or (y+z) is an integer of 0 to 20 inclusive, (CH₂)ⱼC≡CH, or (CH₂)ₖC≡C(CH₂)ᵣ where j or (k+r) is an integer of 0 to 20 inclusive, an aromatic, a heteroaromatic, R³ in each occurrence is independently C₁-C₆ alkyl, Y is C₁-C₄ alkyl, and n is an integer of 0 or 1. Again, it is appreciated that an alkyl as used herein is linear, branched or cyclic with the proviso that cyclic alkyls are C₄-C₆. Strained ring alkoxysilanes operative herein illustratively include 3-glycidoxypropyl methyldiethoxysilane, 3-glycidoxypropyl methyldimethoxysilane, 2-(3,4 epoxycyclohexyl) methyldiethoxysilane, and combinations thereof, along with combinations of formula (IA).

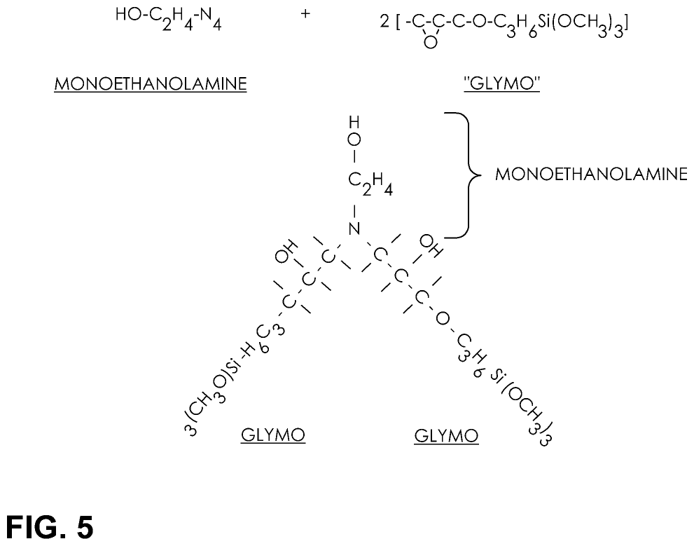

Without intending to be bound to a particular theory, a strained ring alkoxysilane reacts with water to form a silanol with highly reactive hydroxyl groups from the displacement of the alkoxyl groups by hydroxyls. The hydroxyl groups are well-suited to covalently bond to a corrosion prone metal surface or an oxide formed thereon. FIG. 5 illustrates the chemical formation of linked structures that have nitrogen bonded to the ethanol moiety. Crosslinking or chain extension then occurs between the “alcoholyzed” methoxy groups. Mono ethanolamine and two “strained ring alkoxy silanes of gamma glycidoxy propyl trimethoxy silane (GLYMO). Without intending to be bound to a particular theory, it is believed that the reaction of a lower molecular weight amine with an epoxy is a catalyst for alcoholyzation and subsequent “oligomerization” of the product through removal of water and formation of siloxane bonds.

The glycidyl functionality of the strained ring alkoxysilane is readily cured by reaction with an amine or mercaptan functionality associated with a linker chain. The linker chain illustratively includes an aliphatic, a silicone, a perfluorosilicone, an alkoxy silane, an aminoalkyl, a thioalkyl, an aromatic, or a combination thereof. A functional siloxane operative herein has a formula (II):

R^{4′}—[Si(R⁵)(R⁶)—O]ₙ—R⁴ (II)

where R⁴ is independently in each occurrence Si—(C₁-C₄ alkyl)₃, and R^{4′} is Si—(C₁-C₄ alkyl)₃-O—, R⁵ is independently in each occurrence C₁-C₄ alkyl, R⁶ is independently in each occurrence C₁-C₄ alkyl, (C₁-C₆ alkyl)-NH₂, (C₁-C₆ alkyl)-N(H)—C₁-C₆ alkyl, (C₁-C₆ alkyl)-N(H)—(C₁-C₆ alkyl)-NH₂, or (C₁-C₆ alkyl)-SH, with the proviso that at least one occurrence of R⁶ includes a primary amine, secondary amine, a mercaptan, or a combination thereof, and n is an integer between 1 and 50 inclusive. A specific amine functional silicone operative in the present invention is shown in formulas (III) or (IV):

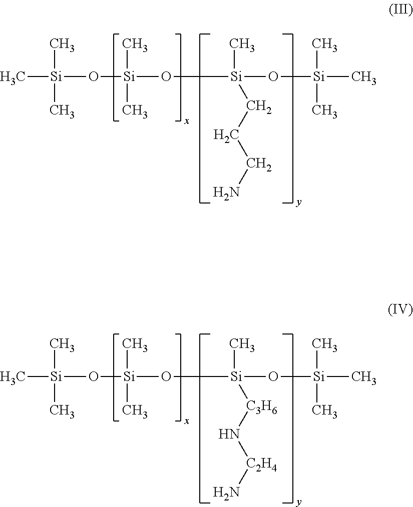

where x is an integer between 1 and 1,000 inclusive, and y is an integer between 1 and 200 inclusive. A corresponding exemplary mercaptan functional silicone is the same as (III) or (IV) with the proviso that the NH₂ moiety is replaced with SH and the NH moiety is replaced by S.

An alkoxy silane operative herein and reactive with the strained ring alkoxy silane has a formula (VA) or (VB):

Q-R⁷—Z—R⁷—Si(OR³) (VA), or

Q-R⁷—Z—R⁷—Si(Yₙ)(OR³)₃₋ₙ (VB)

where Q is H₂N or HS, R⁷ is independently in each occurrence (CH₂)ₘ, or (CH(C₁-C₄ alkyl)CH₂)ₘ, or (CH₂)ₘ—Ar—(CH₂)ₚ, Z is a nullity (yielding a covalent bond R⁷—R⁷) or N(H) or S, m is independently in each occurrence an integer of 0 to 12 inclusive, p is an integer of 0 to 12 inclusive, R³ is independently in each occurrence C₁-C₆ alkyl, and Ar is an aromatic of C₆H₄, or a substituted aromatic in which at least one hydrogen is replaced with a substituent of a halide, thiol, amine (primary, secondary, tertiary or ammonium), hydroxyl, carboxyl, carbonyl, sulfonyl, or alkyl, Y is C₁-C₄ alkyl, and n is an integer of 0 or 1.

The resulting coating has the formula associated with the condensation reaction of one or more equivalents of (I) with (II)-(VB) to form covalent linkages associated with amine or mercaptan cure of epoxides:

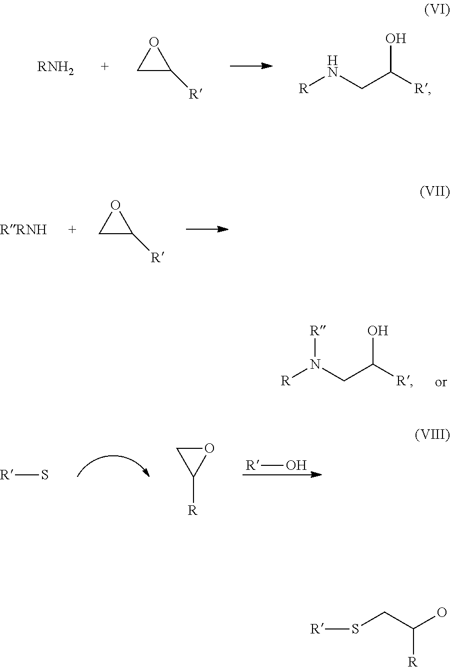

FIG. 5 is a schematic illustrating exemplary bonding to a surface according to the present invention based on amine reaction with the strained ring (I). It is appreciated that the ethoxyl groups extending from the amine nitrogen or aliphatic unsaturation in (I) are amenable to further reaction to modify the properties of the resulting coating. By way of example, such groups are readily esterified to modify coating properties to hydrophobicity of the coating, tether substances to the coating such as nanoparticulate, pigment particles, dye molecules, optical brighteners, electroactive polymers, transition metal complexes, or combinations thereof.

It is appreciated that the curing of the inventive coating constituents readily occurs under a variety of conditions of temperature, pressure, solvents, and atmospheres. These conditions illustratively include ambient temperatures of −10 to 200° C., pressures from 0.0001 to 100 atmospheres pressure, water as a solvent, and atmospheres of air, nitrogen, inert gases; with the only proviso being that the precursors and coating composition are not degraded by the cure conditions. In some inventive embodiments, cure occurs at standard temperature and pressure (STP) cure from a water based or organic solvent.

The reactive compounds of the present invention may be formulated as oil in water emulsions.

In some inventive embodiments, one or more additives are provided to enhance the performance of the resulting adhesive or storage properties of the adhesive composition. Such additive(s) can function as cure inhibitors, open-time promoters, wetting agents, thixotropic agents, thickeners, pH control, preservatives antioxidants, plasticizers, dyes, pigments, and combinations thereof. Examples can include polyamides, polyureas, polyacrylic acids, silica, polyhydroxycarboxylic acid amides, organotitanate and zirconate additives, polyanilines, and metal oxide pigments. Typical addition ranges for these materials range from 0.1-20% by weight.

The present invention is further detailed with respect to the following non-limiting examples. These examples are intended to be illustrative of particular formulations and properties of the inventive coating, and not intended to limit the scope of the appended claims.

### EXAMPLES

### Example 1

A composition of the following is made with the following components:

| | | |
|---|---|---|
| Isopropyl alcohol | 300 | g |
| Formula III, where x = 58, and y = 4 | 40 | g |
| 2-(3,4 epoxycyclohexyl) ethyltrimethoxysilane | 12 | g |
| Distilled water | 5 | g |

The components are mixed overnight at room temperature, then applied by spraying or wiping onto the bottom half of a steel panel (QD-36, Q-Lab Corporation). The coated panel is allowed to dry and cure at room temperature for 24 hours. The coated half surface is smooth, hard, and non-greasy to the touch, and the coating thickness is estimated to be below 5 microns. The panel is sprayed with a 3% aqueous aquarium salt solution to stimulate corrosion, then dried at room temperature. During the drying, the upper (uncoated) half of the panel rusted badly. The coated half showed no visible rusting, though salt crystals form from the drying process.

### Example 2

A second steel panel (QD-36, Q-Lab Corporation) was coated with the composition according to the procedure of Example 1. The coated panel is sprayed with a white enamel spray paint (RUST-OLEUM®) and allowed to dry at room temperature for 24 hours. The paint adhesion is tested using a cross-hatched tape test and showed excellent adhesion.

### Comparative Example A

A composition of the following was made:

| | | |
|---|---|---|
| Isopropyl alcohol | 300 | g |
| Formula III, where x = 58, and y = 4 | 40 | g |
| Distilled water | 5 | g |

These components are mixed overnight at room temperature, then applied by spraying or wiping onto the bottom half of a steel panel (QD-36, Q-Lab Corporation). The coated panel is allowed to dry and cure at room temperature for 24 hours. The panel felt oily to the touch. The panel is sprayed with a 3% aqueous aquarium salt solution to stimulate corrosion, then dried at room temperature.

During the drying, the entire panel showed significant rusting.

### Comparative Example B

A composition of the following was made:

| | | |
|---|---|---|
| Isopropyl alcohol | 300 | g |
| 2-(3,4 epoxycyclohexyl) ethyltrimethoxysilane | 12 | g |
| Distilled water | 5 | g |

These components are mixed overnight at room temperature, then applied by spraying or wiping onto the bottom half of a steel panel (QD-36, Q-Lab Corporation). The coated panel is allowed to dry and cure at room temperature for 24 hours. The panel felt dry to the touch. The panel is sprayed with a 3% aqueous aquarium salt solution to stimulate corrosion, then dried at room temperature. During the drying, the entire panel showed significant rusting.

### Examples 3 and 4

A composition of Example 1 is made with the exception that the composition of Formula III, where x=58, and y=4 is replaced with a like weight amount of Formula IV, where x=400, and y=3.4 (average) and tested per the procedures of Examples 1 and 2, respectively, with like results being obtained.

### Examples 5 and 6

A composition of Example 1 is made with the exception that the composition of 2-(3,4 epoxycyclohexyl) ethyltrimethoxysilane is replaced with a like weight amount of 3-glycidoxypropyl methyldiethoxysilane and panels are tested per the procedures of Examples 1 and 2, respectively, with like results being obtained.

### Examples 7 and 8

A composition of Example 1 is made with the exception that the composition Formula III, where x=58, and y=4 is replaced with a like weight amount of GP-988-1 amino-functional siloxane (Genessee Polymers, Burton, Mich.) and the composition of 2-(3,4 epoxycyclohexyl) ethyltrimethoxysilane is replaced with a like weight amount of 3-glycidoxypropyltrimethoxysilane. The panels are tested per the procedures of Examples 1 and 2, respectively, with like results being obtained.

### Example 9

A composition of Example 1 is made with the exception that the isopropyl alcohol is replaced by acetone. The panels are tested per the procedures of Examples 1 and 2, respectively, with like results being obtained.

As a person skilled in the art will recognize from the previous detailed description and from the figures and claims, modifications and changes can be made to the preferred embodiments of the invention without departing from the scope of this invention defined in the following claims.

1. A structure comprising:
a target substrate having a surface; and
a coating formed by the reaction of at least one equivalent of a formula (IA or IB) with a formula (II) or (V) covalently bonded to the surface; where
a strained ring alkoxysilane operative herein is a monomer or oligomer that typically has an average molecular weight of less than 4,000 Daltons having the formula (IA or IB):
(OCH₂CH)—R¹—X—R²—Si—(OR³)₃ (IA), or
(OCH₂CH)—R¹—X—R²—Si—(Yₙ)(OR³)₃₋ₙ (IB)
where R¹ is C₁-C₄ alkyl, (CH₂)ₓCH═CH₂, or (CH₂)_{y}CH═CH(CH₂)_{z} where x or (y+z) is an integer of 0 to 4 inclusive, (CH₂)ⱼC≡C, or (CH₂)ₖC≡C(CH₂)ᵣ where j or (k+r) is an integer of 0 to 4 inclusive, an aromatic, a heteroaromatic, or together with (OCH₂CH) forms epoxycyclopentyl (OC₅H₇), epoxycyclohexyl (OC₆H₉), or epoxycycloheptyl (OC7H₁₁); X is a nullity or oxygen, R² is C₂-C₆ alkyl, (CH₂)ₓCH═CH₂, or (CH₂)_{y}CH═CH(CH₂)_{z} where x or (y+z) is an integer of 0 to 20 inclusive, (CH₂)ⱼC≡C, or (CH₂)ₖC≡C(CH₂)ᵣ where j or (k+r) is an integer of 0 to 20 inclusive, an aromatic, a heteroaromatic, R³ in each occurrence is independently C₁-C₆ alkyl, Y is C₁-C₄ alkyl, and n is an integer of 0 or 1;
the functional siloxane having a formula (II):
R^{4′}—(Si(R⁵)(R⁶)—O)ₙ—R⁴ (II)
where R⁴ is independently in each occurrence Si—(C₁-C₄ alkyl)₃ and R^{4′} is Si—(C₁-C₄ alkyl)₃-O—, R⁵ is independently in each occurrence C₁-C₄ alkyl, R⁶ is independently in each occurrence C₁-C₄ alkyl, (C₁-C₆ alkyl)-NH₂, (C₁-C₆ alkyl)-N(H)—C₁-C₆ alkyl, (C₁-C₆ alkyl)-N(H)—(C₁-C₆ alkyl)-NH₂, or (C₁-C₆ alkyl)-SH, with the proviso that at least one occurrence of R⁶ includes a primary amine, secondary amine, or a mercaptan, and n is an integer between 1 and 200 inclusive. or
the alkoxy silane having a formula (VA or VB):
Q-R⁷—Z—R⁷—Si(OR³) (VA), or
Q-R⁷—Z—R⁷—Si(Yₙ)(OR³)₃₋ₙ (VB)
where Q is H2N or HS, R⁷ is independently in each occurrence (CH₂)ₘ, or (CH(C₁-C₄ alkyl)CH₂)ₘ, or (CH₂)ₘ—Ar—(CH₂)ₚ, Z is a nullity (yielding a covalent bond R⁷—R⁷) or N(H) or S, m is independently in each occurrence an integer of 0 to 12 inclusive, p is an integer of 0 to 12 inclusive, R³ is independently in each occurrence C₁-C₆ alkyl, and Ar is an aromatic of C₆H₄, or a substituted aromatic in which at least one hydrogen is replaced with a substituent of a halide, thiol, an amine, hydroxyl, carboxyl, carbonyl, sulfonyl, or alkyl, Y is C₁-C₄ alkyl, and n is an integer of 0 or 1.

2. The structure of claim 1 wherein said strained ring alkoxysilane where R¹ is C₁-C₄ alkyl and R² is C₂-C₆ alkyl.

3. The structure of claim 1 wherein said strained ring alkoxysilane where R¹ together with (OCH₂CH) forms (OC₆H₉).

4. The structure of claim 1 wherein said strained ring alkoxysilane is at least one of 2-(3,4 epoxycyclohexyl) ethyltrimethoxysilane, 3-glycidoxypropyl methyldimethoxysilane, 3-glycidoxypropyl trimethoxysilane, 3-glycidoxypropyl methyldiethoxysilane, 3-glycidoxypropyl triethoxysilane, and combinations thereof.

5. The structure of claim 1 wherein said functional siloxane having the formula (II) is present.

6. The structure of claim 5 where R⁴ is in every occurrence the same.

7. The structure of claim 5 where R⁶ in at least one occurrence is (C₁-C₆ alkyl)-NH₂, (C₁-C₆ alkyl)-N(H)—C₁-C₆ alkyl, (C₁-C₆ alkyl)-N(H)—(C₁-C₆ alkyl)-NH₂, or (C₁-C₆ alkyl)-SH.

8. The structure of claim 1 wherein said amine functional silicone has a formula (III) or (IV): 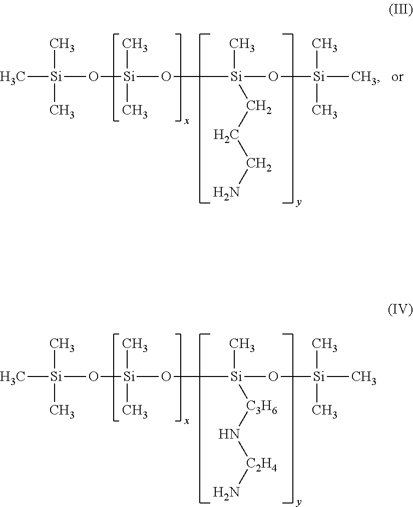
where x is an integer between 1 and 1,000 inclusive, and y is an integer between 1 and 200 inclusive.

9. The structure of claim 1 wherein said alkoxy silane having the formula (VA or VB) is present.

10. The structure of claim 9 where Q is H₂N.

11. The structure of claim 9 where R⁷ is in every occurrence the same.

12. The structure of claim 9 where Z is a nullity.

13. The structure of claim 9 where Z is N(H) or S.

14. The structure of claim 1 wherein said coating has a thickness of between 0.1 and 20 microns and transparent to an unaided normal human eye.

15. The structure of claim 1 wherein said coating is hydrophobic.

16. The structure of claim 1 wherein target substrate is metal.

17. The structure of claim 1 wherein target substrate is steel.

18. The structure of claim 1 wherein target substrate is an external vehicle component.

19. The structure of claim 1 wherein target substrate is aluminum.

20. The structure of claim 1 wherein the surface of said target substrate is metal oxide.
